(19) United States
(12) Patent Application Publication
(10) Pub. No.: US 2026/0137016 A1
(43) Pub. Date: May 21, 2026

(54) AGRICULTURAL TILLAGE IMPLEMENT AND ASSEMBLIES

(71) Applicant: K S Paterson Nominees Pty Ltd, Bute (AU)

(72) Inventor: Kentyn Scot Paterson, Bute (AU)

(21) Appl. No.: 19/120,052

(22) PCT Filed: Oct. 6, 2023
(86) PCT No.: PCT/AU2023/050977

§ 371 Date: Apr. 10, 2025

(30) Foreign Application Priority Data
Oct. 10, 2022 (AU) 2022902971

(51) Int. Cl. A01B 35/16; A01B 35/28

(52) U.S. Cl. CPC A01B 35/16; A01B 35/28

(57) ABSTRACT

An agricultural tilling device has a central portion, and tilling members. The central portion defines a rotational axis about which the device can rotate. The tilling members are to engage the ground. Each tilling member projects generally radially outwardly with respect to the rotational axis from an inner end that is connected to the central portion, to an outer, ground engagement end that defines a radially outer peripheral edge of the tilling member. Each tilling member is configured such that at least one tangential plane, which is substantially coincident with the respective radially outer peripheral edge, is oblique to the rotational axis of the device.

### FIELD OF THE INVENTION

The present invention relates to agricultural tillage implements, and to assemblies for use in agricultural tillage applications.

### BACKGROUND

Agricultural tillage involves manipulation of the soil, for soil and crop management. It is known to till soil to manage crop residue (for example, after a harvest), to control weeds, and to break up a compacted soil top layer. Further it known to till soil in preparation for seed sowing (for example, to turn in applied fertilizers/nutrients, or general seedbed preparation).

Traditional tilling involved deep tilling of soil to essentially bury the top layer and bring up sublayers. This type of tilling practice is currently considered to be very aggressive, and in many environments can be detrimental to the health of the soil. There is also a large power requirement on the tilling equipment to lift and turn soil to these traditional depths.

Present day farming practices tend to favour shallow tillage of soils, typically to a depth of less than 10 cm (approx. 4 inches). Disc chain harrows are now a well adopted implement for shallow tilling of soils.

Some farming practices even encourage “no-till”, which involves minimal disruption to the soil. While the intention of no-till soil management is to leave the soil as undisturbed as possible, it can be necessary to work the soil to foster plant regeneration and/or seed growth. Soil aeration and seed furrows can be achieved in no-till farming operations using vertical tilling equipment, such as wavy coulter discs, finger wheels, and the like. The sole intention of such vertical tilling equipment is to create small openings in the soil, with the least shearing action on the soil (in other words, with the least transverse movement/lateral working of the soil).

There is increasing recognition that one tillage practice doesn't work for all fields in a region (and even within a single farm), and also doesn't work for all seasons. Accordingly, farmers are adapting their soil management practices, including tillage practices, to accommodate for changing environmental conditions. However, this can lead to high equipment cost to the farmer as equipment is often developed for a single purpose.

There is a need to address the above, and/or at least provide a useful alternative.

### SUMMARY

There is provided an agricultural tilling device comprising:
a central portion that defines a rotational axis about which the device is to rotate in use; and
a plurality of tilling members that in use of the device are to engage the ground, each tilling member projects generally radially outwardly with respect to the rotational axis from an inner end that is connected to the central portion, to an outer, ground engagement end that defines a radially outer peripheral edge of the tilling member,
wherein each tilling member is configured such that at least one tangential plane, which is substantially coincident with the respective radially outer peripheral edge, is oblique to the rotational axis of the device.

In at least some embodiments, the radially outer peripheral edge of each tilling member has a single tangential plane. Preferably, the radially outer peripheral edges of the tilling members are generally arcuate.

In some alternatives, the radially outer peripheral edges of the tilling members are generally linear, and
wherein for each tilling member the tangential plane is defined by the respective radially outer peripheral edge and includes a line extending orthogonally from the rotational axis.

Preferably, for each tilling member, a radially outer region, which includes the respective radially outer peripheral edge, extends in the single tangential plane.

In certain embodiments, the tangential planes of all the tilling members are arranged at a common angle to the rotational axis.

Preferably, the tangential planes of all the tilling members are arranged at an angle to the rotational axis that is either less than 45° or greater than 45°. In other words, the tangential planes of all the tilling members are arranged at an angle to the rotational axis that is not 45°.

In some examples, the tangential planes of all the tilling members are arranged at an angle of 40° to the rotational axis.

The tangential planes of the tilling members can be left-handed. Alternatively, the tangential planes of the tilling members can be right-handed.

Preferably, each tilling member has a twist between the central portion and the respective ground engagement end.

In at least some embodiments, each ground engagement end has two major faces, and two side faces that each generally face in a circumferential direction with respect to the rotational axis.

Each tilling member can be configured such that the thickness of at least part of the tilling member tapers in a direction away from the rotational axis.

Alternatively or additionally, each tilling member can include a tip region in which a bevel is formed in at least one of the major faces, such that the thickness of at least the tip region of the tilling member tapers in a direction away from the rotational axis. In at least some preferred embodiments, for each tilling member, the portion of the ground engagement end that is radially inward of the tip region is configured to have a substantially constant thickness.

Preferably, the bevel is formed on one of the two major faces of each respective tilling member.

In at least some embodiments, the central portion forms a flange that spaces the inner ends of the tilling members from the rotational axis by a predefined radius.

In certain embodiments, the central portion defines a mounting formation to mount the device to a carrying structure of an implement. The mounting formation can be configured such that the device, when mounted to the carrying structure is rotationally constrained by interference between the mounting formation and a complementary form of the carrying structure.

The mounting formation can include fastening points that are shaped to provide an interference with fasteners that mount the device to the carrying structure.

The mounting formation can include one or more apertures formed in the central portion.

Preferably, the mounting formation defines a primary aperture that is symmetrical about the rotational axis. More preferably, the primary aperture is non-circular, such that the device can be rotationally constrained on a part of the carrying structure that has a complementary shaped mounting member.

Alternatively or additionally, the mounting formation includes one or more fastening points in the form of secondary apertures through which to pass a fastener to secure the device to the carrying structure.

In preferred embodiments, the device has a connection plane that extends orthogonally to the rotational axis, and also extends through the connections between the inner ends of the tilling members and the central portion.

In some examples, the tilling members and central portion are formed of a continuous piece of material.

Preferably, the central portion has the form of a flat plate.

There is also provided an agricultural tilling assembly that comprises:
a mounting device;
at least one tilling device as previously described that is mountable on the mounting device; and
one or more fastening components or formations,
wherein in the assembled tilling assembly, the fastener components or formations act to retain tilling device in a mounted condition on the mounting device.

In at least some embodiments, the mounting device has a longitudinal axis, and wherein when the tilling device is mounted on the mounting device, the rotational axis of the tilling device is parallel to the longitudinal axis of the mounting device assembly.

In use of the agricultural tilling assembly, the assembly is positionable with the longitudinal axis generally parallel with ground to be tilled, and at an elevation such that at least the tip region of at least one of the tilling members will engage with the ground, and
whereby, when the assembly is positioned with the longitudinal axis at a predefined oblique angle to a direction of movement of the assembly, the tilling device rotates to enable the tilling members to penetrate the ground sequentially, and substantially without inducing transverse movement of the soil.

In certain embodiments, the mounting device has a first connecting member, and a second connecting member,
wherein the first and second connecting members have complementary shapes, the complementary shapes being such that the shape of the first connecting member permits interengagement with the second connecting member,
whereby the tilling assembly is interconnectable with another like assembly by interconnection of respective first and second connecting members.

In some examples, the first connecting member includes a hooking formation that defines a bight portion, and terminates in an outer end.

In at least some embodiments, the second connecting member defines an eye through which the outer end of the first connecting member can pass, with the second connecting portion locating within the bight portion. In certain alternative embodiments, the second connecting member can include a hooking formation that defines a bight portion, and terminates in an outer end.

Preferably, the first and second connecting members are configured such that adjacent interconnected tilling assemblies are pivotable relative to one another.

In at least some examples, the mounting device includes a hub about which to locate at least part of the mounting formation of the tilling device.

There is also provided an agricultural tilling chain that comprises:
a plurality of agricultural tilling assemblies as previously described,
wherein the tilling assemblies are interconnected with one another to define an elongate structure.

There is also provided an agricultural tillage implement, comprising:
a frame that is to pulled by a vehicle in a working direction;
one or more elongate structures that are each connected to the frame, each elongate structure including:
   a plurality of agricultural tilling devices as previously described; and
   a plurality of mounting members that are each configured to mount the tilling devices in a spaced apart relationship in the elongate direction of the respective elongate structure, and such that the rotational axes of the respective tilling devices are tangential to the elongate direction,
wherein the frame is configured to locate the elongate structures:
   with the longitudinal axes generally parallel with ground to be tilled, and within a range of predefined elevations in which the tilling members of the tilling devices can penetrate the ground, and
   with the elongate direction of each elongate structure at a predefined oblique angle to the working direction of the implement,
   such that the tilling devices rotate to enable the tilling members to penetrate the ground sequentially.

Preferably, the tillage implement further comprises rotary couplings, and wherein opposing ends of each elongate structure is connected or is connectable to the frame by the rotary couplings,
whereby, in use of the implement, each elongate structure is to rotate about the respective longitudinal axis.

Preferably, each elongate structure is mountable at a first set of locations on the frame, and/or in a first set of orientations, such that tilling members penetrate the ground sequentially, and substantially without inducing transverse movement of the soil.

Preferably, each elongate structure is mountable at a second set of locations on the frame, and/or in a second set of orientations, such that tilling members penetrate the ground sequentially, and are also disposed to induce transverse movement of the soil.

In some examples in which the tillage implement has two or more elongate structures, the elongate structures can be arranged on the frame such that:
all tilling members are to penetrate the ground substantially without inducing transverse movement of the soil;
all; or
a first set of the tilling members are to penetrate the ground substantially without inducing transverse movement of the soil, and a second set of the tilling members are to penetrate the ground so as to induce transverse movement of the soil.
In at least some embodiments, the tillage implement has four or more elongate structures.

### BRIEF DESCRIPTION OF THE DRAWINGS

In order that the invention may be more easily understood, embodiments will now be described, by way of example only, with reference to the accompanying drawings, in which:

FIG. 1: is a perspective view of a tilling disc and mounting hub assembly according to a first embodiment of the invention;

FIG. 2: is a front view of the tilling disc and mounting hub assembly of FIG. 1;

FIG. 3: is a side view of the tilling disc and mounting hub assembly of FIG. 1;

FIG. 4: is another perspective view of the tilling disc and mounting hub assembly of FIG. 1;

FIG. 5: is a perspective view of a tilling disc and mounting hub assembly according to a second embodiment of the invention;

FIG. 6: is a front view of the tilling disc and mounting hub assembly of FIG. 5;

FIG. 7: is a side view of the tilling disc and mounting hub assembly of FIG. 5;

FIG. 8: is a perspective view of the tilling disc shown in FIG. 1;

FIG. 9: is a perspective view of the tilling disc shown in FIG. 5;

FIG. 10: is a front view of the tilling disc shown in FIG. 1;

FIG. 11: is a front view of the tilling disc shown in FIG. 5;

FIG. 12: is a side view of the tilling disc shown in FIG. 1;

FIG. 13: is a side view of the tilling disc shown in FIG. 5;

FIG. 14: is a section view of the tilling disc, as viewed along line X-X in FIG. 13;

FIG. 15: is an agricultural tilling chain formed from a plurality of tilling disc and mounting hub assemblies as shown in FIG. 1;

FIG. 16: is an agricultural tilling chain formed from a plurality of tilling disc and mounting hub assemblies as shown in FIG. 5;

FIG. 17: is a schematic view of an agricultural tilling implement according to a third embodiment, and assembled for shallow tillage of soil;

FIG. 18: is a schematic illustration of the tilling disc blade engagement in the soil for the implement as shown in FIG. 17;

FIG. 19: is a schematic view of the agricultural tilling implement of FIG. 17, and assembled for vertical slicing tillage of soil;

FIG. 20: is a schematic illustration of the tilling disc blade engagement in the soil for the implement as shown in FIG. 19;

FIG. 21: is a schematic view of an agricultural tilling implement according to a fourth embodiment, and assembled for shallow tillage of soil; and

FIG. 22: is a schematic illustration of the tilling disc blade engagement in the soil for the implement as shown in FIG. 21.

### DETAILED DESCRIPTION

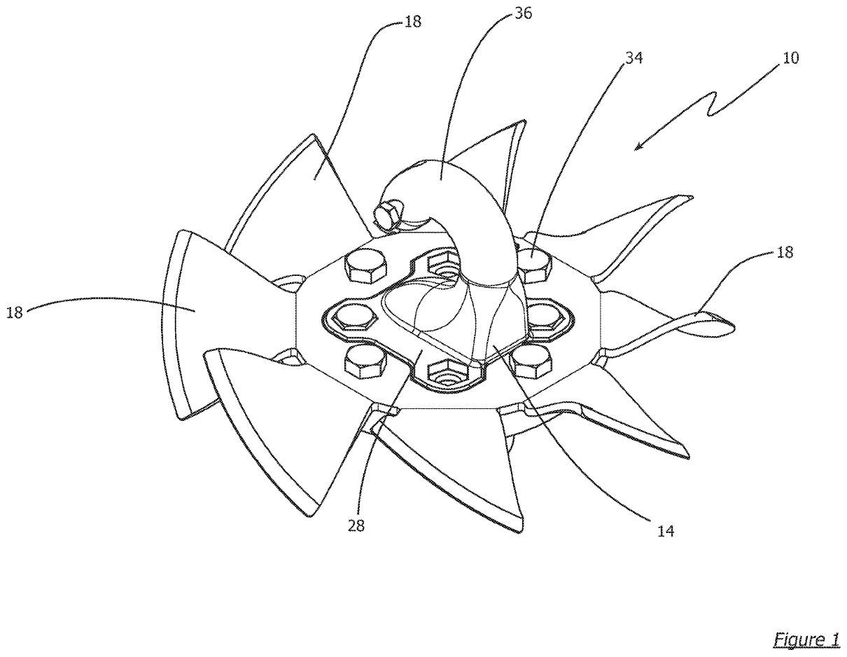

FIGS. 1 to 4 show an agricultural tilling assembly 10 according to a first embodiment. The tilling assembly 10 includes a tilling device, which in this example is in the form of a tilling disc 12, and mounting device 14.

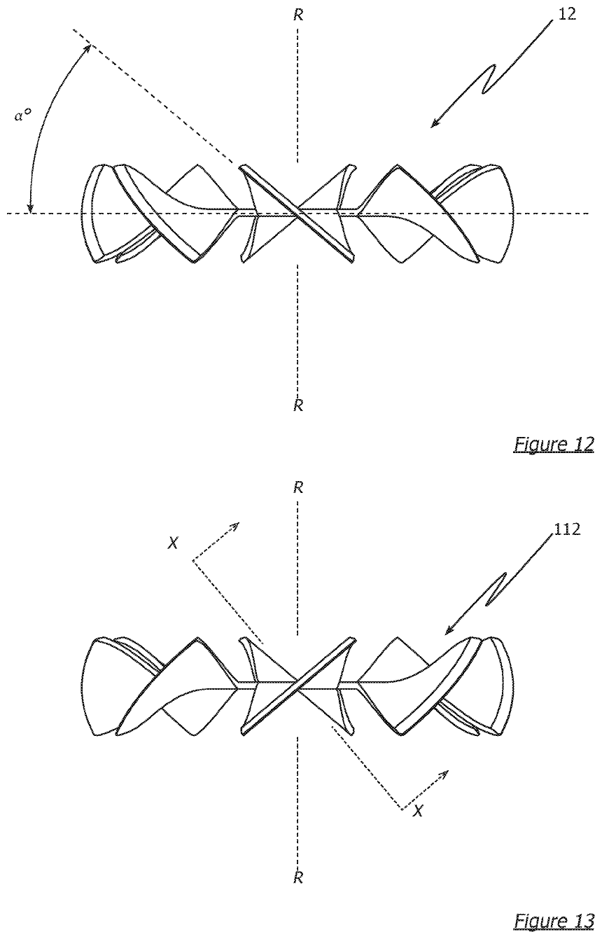

The tilling disc 12 of the embodiment shown in FIGS. 1 to 4 is described in further detail in reference to FIGS. 8, 10 and 12. As shown in these Figures, the tilling disc 12 has a central portion 16. The tilling disc 12 has a rotational axis R (shown in FIG. 12) about which the tilling disc 12 is to rotate in use. A plurality of tilling members (hereinafter referred to as “blades 18”) that in use of the tilling disc 12 are to engage the ground. Each blade 18 projects generally radially outwardly with respect to the rotational axis R from an inner end that is connected to the central portion 16, to an outer, ground engagement end 20. The ground engagement end 20 defines a radially outer peripheral edge 22 of the tilling disc 12.

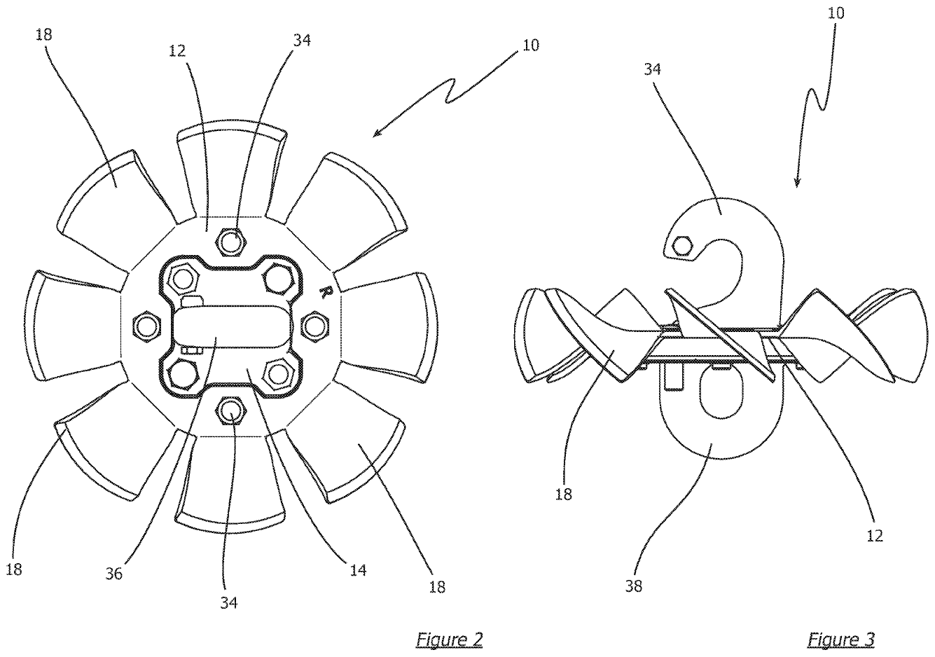

Each blade 18 is configured such that at least one tangential plane, which is substantially coincident with the respective radially outer peripheral edge 22, is oblique to the rotational axis R. For each tilling member, the respective tangential plane is defined by the corresponding radially outer peripheral edge, and a line extending orthogonally from the rotational axis R lies in that tangential plane. As shown in FIG. 12, in this example, the radially outer peripheral edge 22 of each blade 18 has a single tangential plane (as shown in FIG. 12). Further, the radially outer peripheral edge of each blade 18 is generally arcuate (in other words, is curved), as shown particularly in FIGS. 2 and 10.

In the particular example illustrated in FIGS. 1 to 4, each blade 18 is configured the respective radially outer peripheral edge 22 is entirely coincident with its corresponding tangential plane.

In this example, the tangential planes of all the blade 18 are arranged at a common angle to the rotational axis R. FIG. 12 indicates the blade plane angle α° to a centre plane of the tilling disc 12; the rotational axis R being normal (in other words, perpendicular) to the centre plane. In this example, the blade plane angle α° is approximately 40°.

The tilling disc 12 has a forward face 24. As is shown in FIGS. 2 and 12, the blades 18 of the tilling disc 12 are inclined to form a left-handed set. In other words, when the tilling disc 12 is viewed from the side (as in FIGS. 2 and 12), the radially outer peripheral edges 22 are angled upward to the left (so that each radially outer peripheral edge 22 has an appearance similar to a backslash “\”).

Each blade 18 has a tip region in which a bevel 26 is formed on the side of the forward face 24. Accordingly, the thickness of at least the tip region of each blade 18 tapers in a direction away from the rotational axis R.

Each blade 118 has a twist between the central portion 16 and the radially outer peripheral edge 22.

The central portion 16 forms a flange that spaces the inner ends of the blades 18 from the rotational axis R by a predefined radius. Further, the central portion 16 has the form of a flat plate.

In this particular example, the mounting device 14 includes a hub portion 28 on which the tilling disc 12 is to be mounted. The central portion 16 of the tilling disc 12 has a mounting formation that includes a primary aperture 30, and a set of secondary apertures 32 through which to pass fasteners 34 to secure the tilling disc 12 to the mounting device 14.

The primary aperture 30 is non-circular, and has a shape that complements part of the hub portion 28. In this way, when the tilling disc 12 is mounted to the mounting device 14, the tilling disc 12 is rotationally constrained on the mounting device 14.

The mounting device 14 also has a first connecting member, and a second connecting member. In this example, the first connecting member is in the form of a hook 36, and the second connecting member is in the form of an eye formation 38. The hook 36 and the eye formation 38 have complementary shapes, in that the shape of the hook 36 permits interengagement with the eye formation 38. Accordingly, the agricultural tilling assembly 10 is interconnectable with another assembly by interconnection of respective hook 36 with the eye formation 38.

Hence, as shown in FIG. 15, a chain 200 can be assembled by interconnecting a set of agricultural tilling assemblies 10 in series to form an elongate structure.

The interconnection of the hooks 36 with the eye formations 38 is such that adjacent interconnected tilling assemblies 12 are pivotable relative to one another. Accordingly, the pivotable interconnections of the hooks 36 with the eye formations 38 allows the chain 200 to be curved along its length and in at least one plane.

It should be appreciated from FIG. 15 that within the chain 200 the tilling discs 12 are spaced apart in the elongate direction of the elongate structure formed by the chain 200. The rotational axes of the tilling discs 12 are tangential to the elongate direction of the chain 200. Hence, in the scenario in which the elongate direction of the chain 200 is straight (for example, as illustrated in FIG. 15) and thus the elongate direction is linear, the rotational axes of the tilling discs 12 are parallel to a longitudinal axis of the chain 200.

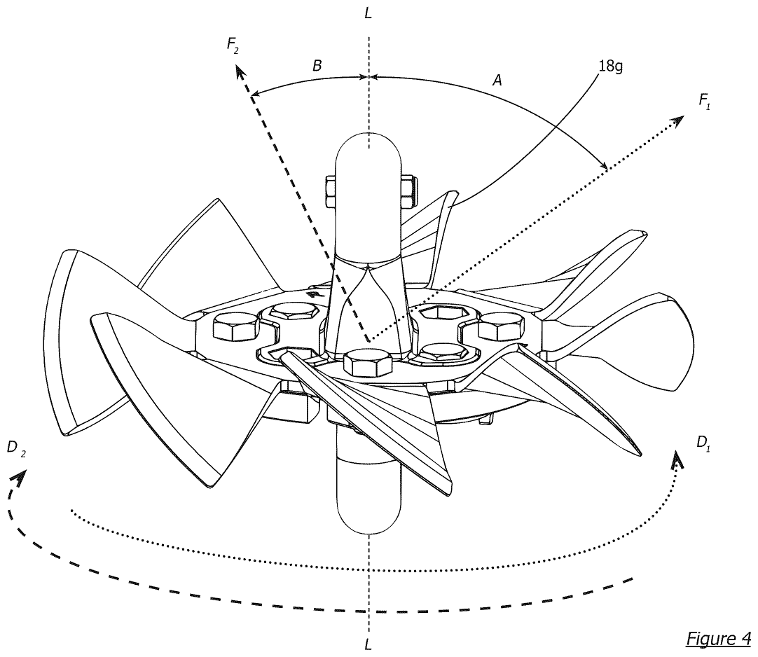

As shown in FIG. 4, each mounting device 14 has a longitudinal axis L. As will be evident from FIGS. 4 and 12, when the tilling disc 12 is mounted on the mounting device 14 the rotational axis of R of the tilling device 12 is parallel to, and co-incident with the longitudinal axis L of the mounting device assembly.

In the illustrated examples, the tilling disc 12 is configured such that the blades 18 are spaced apart with respect to one another in the circumferential direction. Hence, when viewed in a direction parallel with the rotational axis R (as is the case in FIG. 10), the radially outer peripheral edges 22 of adjacent blades 18 have a separation. As should be apparent from FIG. 10, the length of the radially outer peripheral edge 22 of each blade 18 is greater than the circumferential separation of adjacent pair of blades 18.

The tilling disc 12 is configured such that inner ends of adjacent blades 18 are spaced in a circumferential direction.

In use, the tilling assembly 10 is to be positioned with the longitudinal axis L generally parallel with the ground that is to be tilled. Further, the longitudinal axis L is to be at an elevation that enables at least the tip region of at least one the blades 18 to engage with the ground. In addition, the tilling assembly 10 is configured to have the longitudinal axis L positioned at an oblique angle to the forward direction of movement of the tilling assembly 10. The purpose of this is configuration is discussed in further detail below, in connection with FIGS. 17 to 20.

FIG. 4 illustrates the tilling assembly 10 from an inclined plan view. One of the blades (identified as 18g in FIG. 4) is to be engaged with the ground. With the tilling assembly 10 in this arrangement, it is shown that when the tilling assembly 10 is positioned with the longitudinal axis L at a first angle A to a first forward direction of movement F₁, the inclination of the blade plane angle α° causes a rotation of the tilling assembly 10 in a first direction D₁ about the longitudinal axis L. In this example with the blade angle being approximately 40°, the first angle A is also approximately 40°.

Conversely, with the tilling assembly 10 in this same arrangement, it is also shown in FIG. 4 that when the tilling assembly 10 is positioned with the longitudinal axis L at a second angle B to a second forward direction of movement F₂, the inclination of the blade plane angle α° causes a rotation of the tilling assembly 10 in a second direction D₂ about the longitudinal axis L. In this example with the blade angle being approximately 40°, the second angle B is approximately 10°.

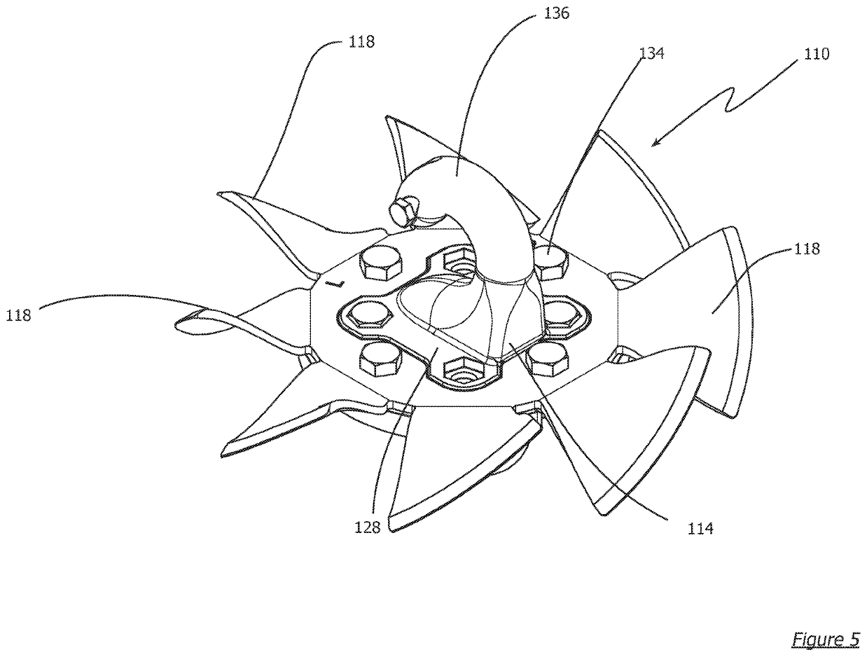

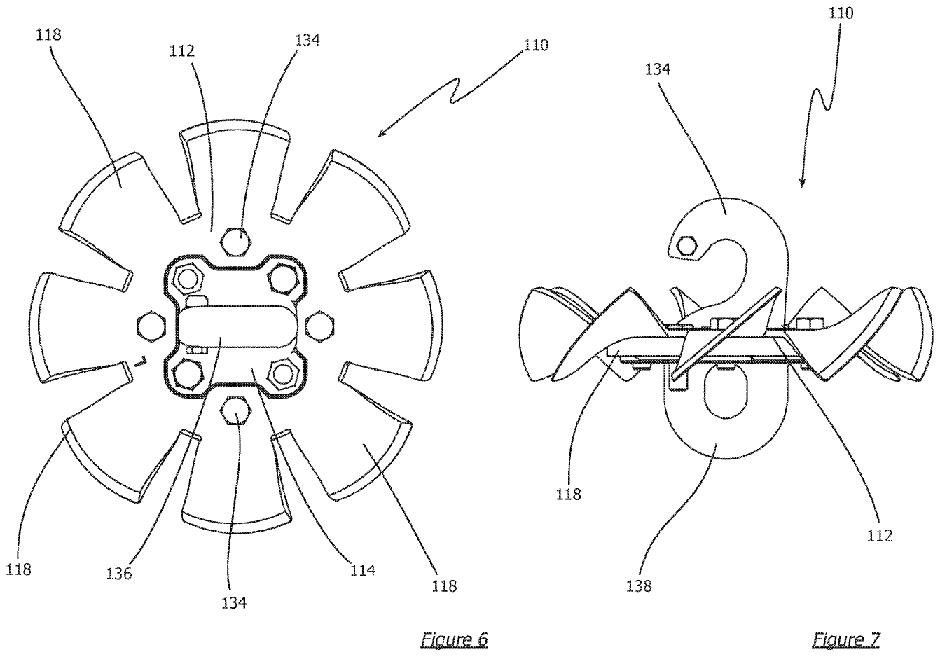

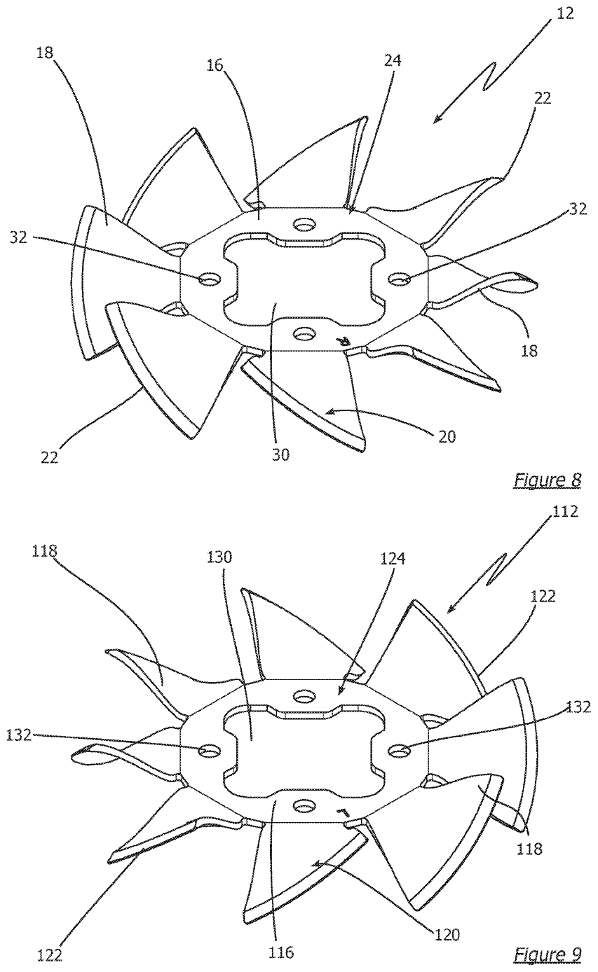

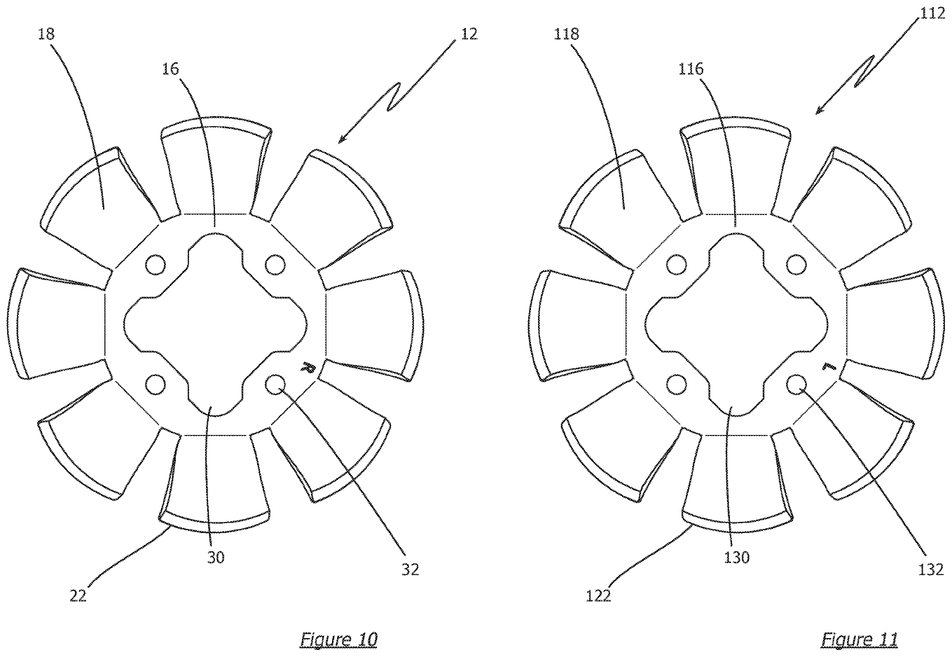

FIGS. 5 to 7 show an agricultural tilling assembly 110 according to a second embodiment. Parts of the tilling assembly 110 that are the same or similar to parts of the tilling assembly 10 have the same reference numbers with the prefix “1” and for succinctness, will not be described again. The tilling disc 112 of the embodiment shown in FIGS. 5 to 7 is described in further detail in reference to FIGS. 9, 11, 13 and 14.

The agricultural tilling assembly 110 differs from the tilling assembly 10 only in that the blades 118 of the tilling disc 112 are inclined to form a right-handed set. In other words, when the tilling disc 112 is viewed from the side (as in FIGS. 5 and 13), the radially outer peripheral edges 122 are angled upward to the right (so that each radially outer peripheral edge 122 has an appearance similar to a forward slash “/”).

In the examples illustrated in FIGS. 12 and 13, the radially outer edges 22, 122 of the blades 18, 118 of the respective tilling disc 12, 112 lies entirely within the respective tangential plane. Hence, when viewed orthogonally to the rotational axis R and parallel with the radial direction of each blade 18, 118 (as per FIGS. 12, and 13), the radially outer edge 22, 122 appears linear.

In some non-illustrated examples of the tilling disc, the radially outer peripheral edge of at least some of the blades can be contoured. In this way, those radially outer peripheral edges can appear non-linear, when viewed orthogonally to the rotational axis R and parallel with the radial direction of each blade.

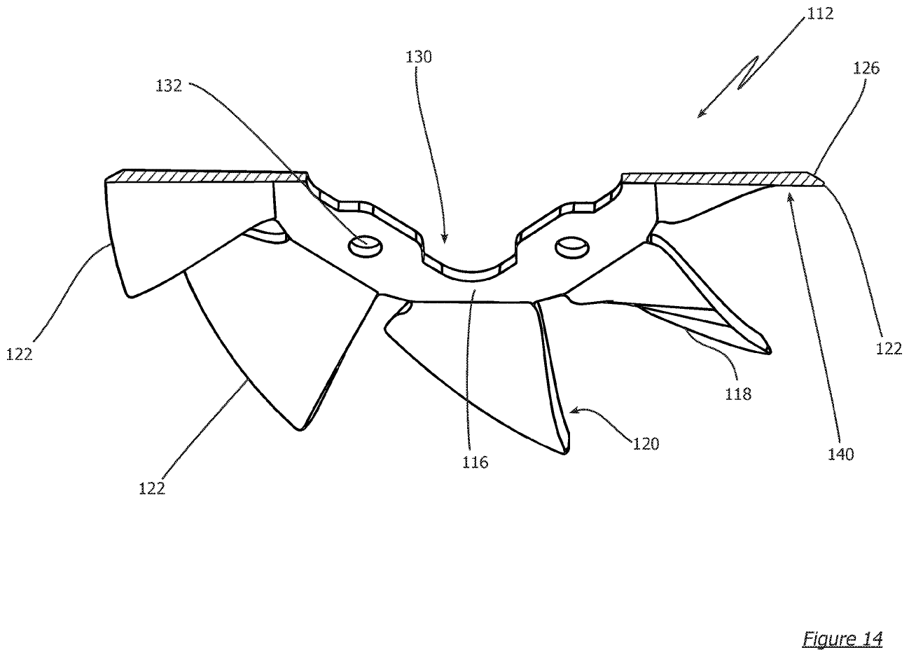

FIG. 14 shows the tilling disc 112 in cross-section. From FIG. 14, it will be apparent that the tilling disc 112 includes a radially outer region 140 extends in the single tangential plane. The radially outer region 140 includes the radially outer peripheral edge 122 of the respective blade 118. Between the central portion 116 and the radially outer region 140 each blade 118 has a twist.

In this particular example, the material thickness of the central portion 116, the parts of the blades 118 that are radially inward of the bevel 126 is substantially constant. In this regard, it is noted that the representation of FIG. 14, the above described twist in each of the blades 118, combined with the angle at which the cross-section is taken, results in an apparent distortion in the thickness within the two sectioned blades.

It will be understood that the information shown in FIG. 14, and described in reference thereto in respect of the tilling disc 112 also applies to the tilling disc 12.

In the examples illustrated in the figures, the tilling discs form a complete annular component. It should be appreciated that in some alternatives, tilling discs can be formed from two or more components that are annular sectors.

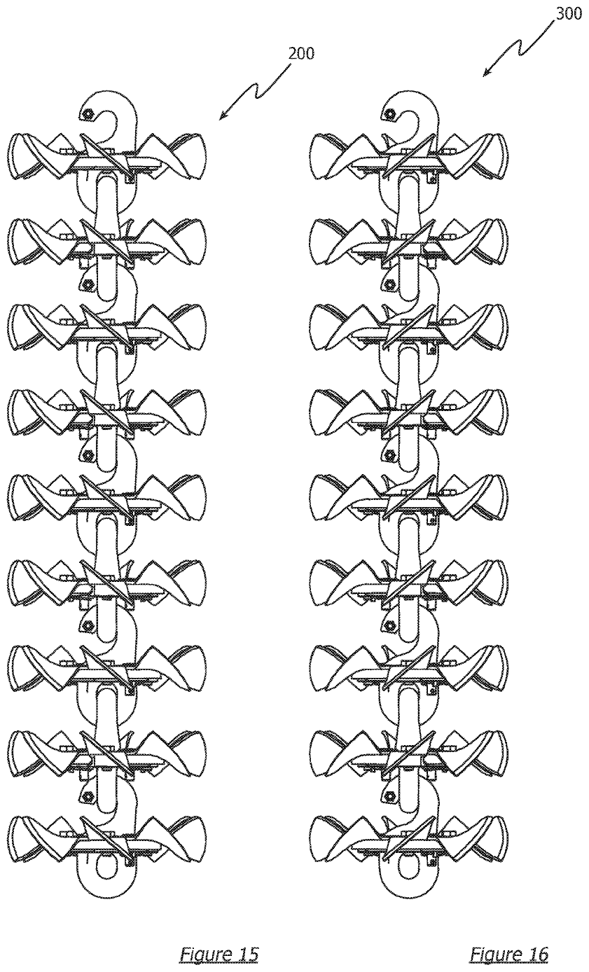

FIG. 16 shows a chain 300 assembled by interconnecting a set of agricultural tilling assemblies 110 in series to form an elongate structure. In this regard, the chain 300 is substantially similar to the chain 200 that is assembled by interconnecting the set of tilling assemblies 10.

FIG. 17 illustrates a schematic agricultural tillage implement 400. It will be appreciated that the tilling implement 400 is shown here for illustrative purposes only, and for use in describing a principle of operation. The schematic agricultural tillage implement 400 is not intended to represent a workable agricultural implement. However, functional deficiencies in the schematic implement are not material to this disclosure.

The schematic agricultural tillage implement 400 includes a frame 402 that is configured to be pulled in a forward direction F by a vehicle (not shown). The schematic agricultural tillage implement 400 includes multiple chains 200, 300 as previously described, which are connected to the frame 402. To this end, rotational couplings 404 are located between the structural parts of the frame 402 and the ends of the chains 200, 300. Hence, in use of the schematic agricultural tillage implement 400 the chains 200, 300 are able to rotate about their respective longitudinal axis.

Tensioning mechanisms (not shown) can also be included in the schematic agricultural tillage implement 400 to adjust the tension in each chain 200, 300.

The frame 402 is arranged to mount the chains 200, 300 at oblique angles Q° to the forward direction F. In this particular example, the oblique angle Q° is approximately 40°.

In the arrangement illustrated in FIG. 17, the schematic agricultural tillage implement 400 has two chains 200 that are each assembled with a set of tilling assemblies 10. Having regard to the forward direction F of the schematic agricultural tillage implement 400, the two chains 200 are mounted at each of the left front quadrant, and the right rear quadrant. Further, the schematic agricultural tillage implement 400 has two chains 300 that are each assembled with a set of tilling assemblies 110. Having regard to the forward direction F of the schematic agricultural tillage implement 400, the two chains 300 are mounted at each of the right front quadrant, and the left rear quadrant.

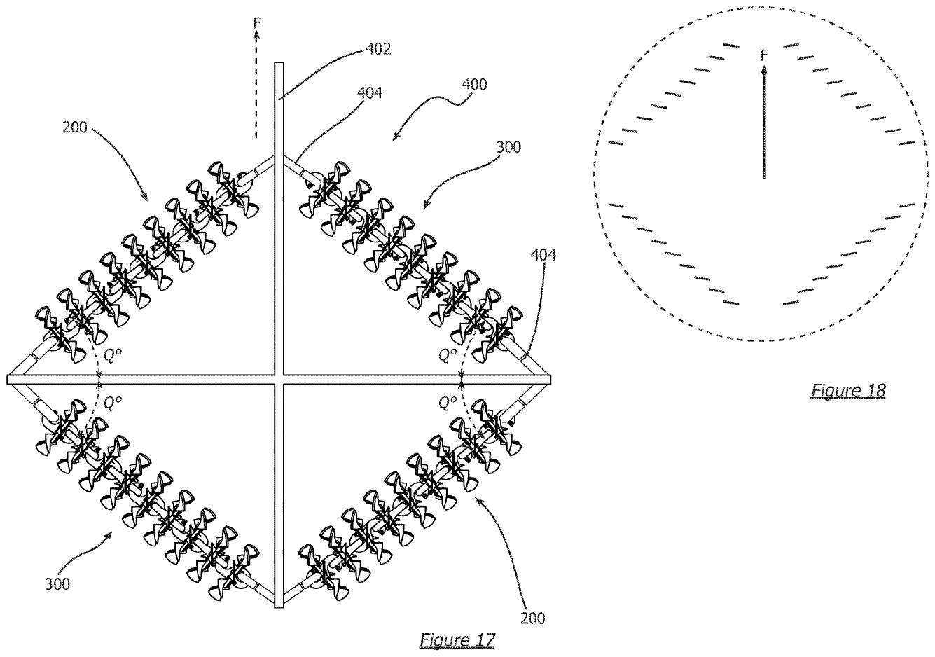

FIG. 18 illustrates the relative orientations of the blades of the chains 200, 300 that are in engagement with the ground beneath the schematic agricultural tillage implement 400 for the configuration illustrated in FIG. 17. FIG. 18 also indicates the forward direction F of the schematic agricultural tillage implement 400.

With each of the chains 200, 300 mounted in the above described positions, the engagement of the blades with the ground is such that the blades 18, 118 of the assemblies 10, 110 penetrate the ground sequentially with rotation of the respective chain. Further, the orientation of the blades 18, 118 induces a transverse movement of the soil. In this way, the tillage of the soil can some lifting and turning of the soil.

FIG. 19 illustrates the schematic agricultural tillage implement 400, with the positions of the chains 200, 300 interchanged. To this end, the two chains 200 are mounted on the frame 402 at each of the right front quadrant, and the left rear quadrant. Further, the two chains 300 are mounted at each of the right front quadrant, and the right rear quadrant. Further, the two chains 300 are mounted at each of the left front quadrant, and the right rear quadrant.

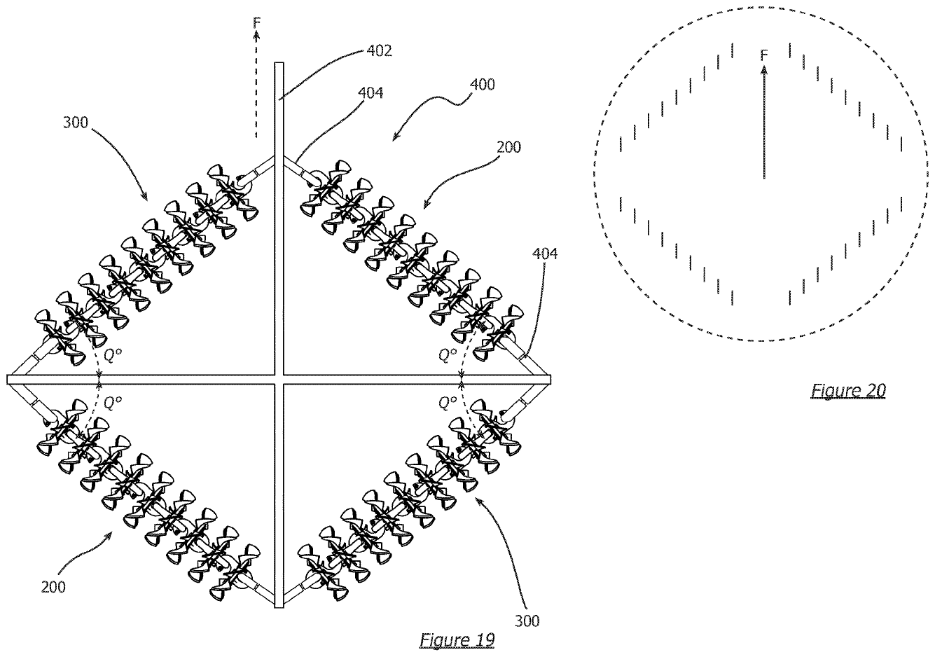

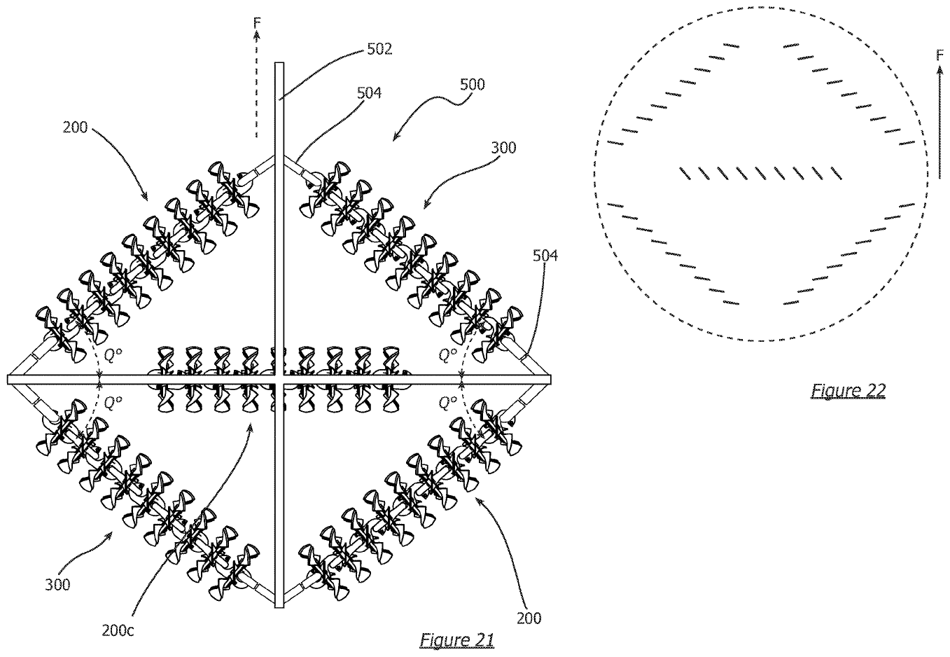

FIG. 20 illustrates the relative orientations of the blades of the chains 200, 300 that are in engagement with the ground beneath the schematic agricultural tillage implement 400 for the configuration illustrated in FIG. 19. FIG. 20 also indicates the forward direction F of the schematic agricultural tillage implement 400.

With each of the chains 200, 300 mounted in the above described positions, the engagement of the blades with the ground is such that the blades 18, 118 of the assemblies 10, 110 penetrate the ground sequentially with rotation of the respective chain. Further, as will be apparent from FIG. 20, the orientation of the blades 18, 118 is substantially parallel to the forward direction F. Hence, the tilling action of the schematic agricultural tillage implement 400 in this configuration induces negligible transverse movement of the soil. The configuration illustrated in FIG. 19 can be considered to correspond with a vertical tilling operation.

It will be appreciated that an agricultural tilling implement with tilling chains 200, 300 arranged in the manner illustrated schematically in FIGS. 17 and 19 provides the flexibility to adopt either vertical tilling of the soil, or light tilling that induces lateral movement in the soil. Accordingly, the same implement can be used for multiple different tilling actions.

Each of the tilling assemblies 10, 100 can additionally incorporate one or more weight plates (not shown) of the type and configuration that is described and illustrated in International Patent Publication No. WO 2019/036772 A1 (filed in the name of K S Paterson Nominees Pty Ltd), the entire disclosure of which is incorporated herein by reference. As described in WO 2019/036772, the ability to releasably mount weight plates on the tilling assemblies 10, 100 facilitates the alteration of the overall weight of the chains, which allows selective adjustment of the depth of penetration of the tilling discs 12, 112.

FIG. 21 illustrates a schematic agricultural tillage implement 500. The schematic agricultural tillage implement 500 is similar to the schematic agricultural tillage implement 400. Component parts of the schematic agricultural tillage implement 500 that are similar to that of the schematic agricultural tillage implement 400 have the same reference numerals, with the prefix “5” replacing the prefix “4”. For brevity, these similar component parts are not described again.

Compared with the schematic agricultural tillage implement 400 includes a fifth chain 200c. The fifth chain 200c is mounted on the frame 502, in a position that is central with respect to the other four chains 200, 300. The schematic agricultural tillage implement 500 includes rotational couplings (not shown) that are located between the structural parts of the frame 502 and the ends of the fifth chain 200c. Further, the fifth chain 200c is perpendicular to the forward direction F of the schematic agricultural tillage implement 500.

It should be appreciated that the fifth chain 200c facilitates tillage of soil that is located between the lateral pairs of chains 200, 300, and over which the schematic agricultural tillage implement 500 would otherwise travel (in the forward direction F) without the lateral pairs of chains 200, 300 tilling the soil beneath the schematic agricultural tillage implement 500.

In other examples that are similar to that illustrated in FIG. 21, the central chain may be parallel with the forward direction F of the implement, or oblique to the forward direction F. Further, the central chain may be aligned for inducing transverse movement of the soil (as is the case in FIG. 21), or for vertical tilling operations.

It should be appreciated that the number and position of chains with respect to the frame of an agricultural tilling implement can vary from the illustrated forms, without departing from the principle of operation.

Agricultural tilling implements according to other non-illustrated examples may use one or more chains that arranged to induce transverse movement of the soil, together with chains that arranged for vertical tilling operation on the soil. In such examples, the chains for transverse movement of the soil can be ahead of the chains vertical tilling of the soil, or vice versa.

It should also be appreciated that a chain (not shown) can be assembled in which one or more tilling assemblies 10 are interconnected with one or more tilling assemblies 100. As the pressure of the soil on the tilling assemblies 10, 100 would urge rotation in opposite directions, the chain may incorporate rotational couplings the between each pairs of adjacent and non-identical assemblies 10, 100.

Tilling implements may incorporate chains of the type described herein, including as illustrated in reference to the drawings, in addition to other tilling equipment/tool assemblies that perform other tilling operations on soil. Examples of other tilling equipment include primary tools and rear tools (such as rolling baskets). Further, the other tilling equipment can be mounted on the implement frame either mounted in front of chains substantially as disclosed herein as a “pre disturbance tool”, or to the rear of the chains substantially as disclosed herein as a levelling/finishing tool.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An agricultural tilling device comprising:
a central portion that defines a rotational axis about which the device is configured to rotate in use; and
a plurality of tilling members that in use of the device are configured to engage the ground, each tilling member projecting generally radially outwardly with respect to the rotational axis from an inner end that is connected to the central portion, to an outer, ground engagement end that defines a radially outer peripheral edge of the tilling member,
wherein each tilling member is configured such that at least one tangential plane, which is substantially coincident with the respective radially outer peripheral edge, is oblique to the rotational axis of the device,
wherein the radially outer peripheral edge of each tilling member has a single tangential plane, and the tangential planes of all the tilling members are arranged at a common angle to the rotational axis, and
wherein the tangential planes of all the tilling members are arranged at an angle to the rotational axis that is either less than 45° or greater than 45°.

2. (canceled)

3. The agricultural tilling device of claim 1, wherein the radially outer peripheral edges of the tilling members are generally arcuate.

4. (canceled)

5. (canceled)

6. The agricultural tilling device of claim 1, wherein the tangential planes of all the tilling members are arranged at an angle of 40° to the rotational axis.

7. The agricultural tilling device of claim 1, wherein the tangential planes of the tilling members are either left-handed, or are right-handed.

8. (canceled)

9. The agricultural tilling device of claim 1, wherein each ground engagement end has two major faces, and two side faces that each generally face in a circumferential direction with respect to the rotational axis.

10. The agricultural tilling device of claim 1, wherein each tilling member is configured such that the thickness of at least part of the tilling member tapers in a direction away from the rotational axis.

11. The agricultural tilling device of claim 1, wherein each tilling member includes a tip region in which a bevel is formed in at least one of the major faces, such that the thickness of at least the tip region of the tilling member tapers in a direction away from the rotational axis.

12. (canceled)

13. (canceled)

14. The agricultural tilling device of claim 1, wherein the central portion forms a flange that spaces the inner ends of the tilling members from the rotational axis by a predefined radius.

15. The agricultural tilling device of claim 1, wherein the central portion defines a mounting formation configured to mount the device to a carrying structure of an implement.

16.-21. (canceled)

22. An agricultural tilling assembly that comprises:
a mounting device;
at least one tilling device according to claim 1, and that is mountable on the mounting device; and
one or more fastening components or formations,
wherein in the assembled tilling assembly, the fastener components or formations are configured to retain the tilling device in a mounted condition on the mounting device.

23. The agricultural tilling assembly of claim 22, wherein the mounting device has a longitudinal axis, and wherein when the tilling device is mounted on the mounting device, the rotational axis of the tilling device is parallel to the longitudinal axis of the mounting device assembly.

24. The agricultural tilling assembly of claim 22, wherein the assembly is positionable with the longitudinal axis generally parallel with ground to be tilled, and at an elevation such that at least the tip region of at least one of the tilling members will engage with the ground, and
whereby, when the assembly is positioned with the longitudinal axis at a predefined oblique angle to a direction of movement of the assembly, the tilling device rotates to enable the tilling members to penetrate the ground sequentially, and substantially without inducing transverse movement of the soil.

25. The agricultural tilling assembly of claim 22, wherein the mounting device has a first connecting member, and a second connecting member,
wherein the first and second connecting members have complementary shapes, the complementary shapes being such that the shape of the first connecting member permits interengagement with the second connecting member,
whereby the tilling assembly is interconnectable with another like assembly by interconnection of respective first and second connecting members.

26. An agricultural tilling chain that comprises:
a plurality of agricultural tilling assemblies according to claim 22,
wherein the tilling assemblies are interconnected with one another to define an elongate structure.

27. An agricultural tillage implement comprising:
a frame configured to be pulled by a vehicle in a working direction; and
one or more elongate structures that are each connected to the frame, each elongate structure including:
a plurality of agricultural tilling devices according to claim 1; and
a plurality of mounting members that are each configured to mount the tilling devices in a spaced apart relationship in the elongate direction of the respective elongate structure, and such that the rotational axes of the respective tilling devices are tangential to the elongate direction, wherein the frame is configured to locate the elongate structures:
with the longitudinal axes generally parallel with ground to be tilled, and within a range of predefined elevations in which the tilling members of the tilling devices can penetrate the ground, and
with the elongate direction of each elongate structure at a predefined oblique angle to the working direction of the implement,
such that the tilling devices rotate to enable the tilling members to penetrate the ground sequentially.

28. The agricultural tillage implement of claim 27, further comprising a plurality of rotary couplings, and wherein opposing ends of each elongate structure is connected, or is connectable to the frame by the rotary couplings,
whereby, in use of the implement, each elongate structure is configured to rotate about the respective longitudinal axis.

29. The agricultural tillage implement of claim 27, wherein each elongate structure is mountable at a first set of locations on the frame, and/or in a first set of orientations, such that tilling members penetrate the ground sequentially, and substantially without inducing transverse movement of the soil.

30. The agricultural tillage implement according of claim 29, wherein each elongate structure is mountable at a second set of locations on the frame, and/or in a second set of orientations, such that tilling members penetrate the ground sequentially, and are also disposed to induce transverse movement of the soil.
